(19) United States
(12) Patent Application Publication
(10) Pub. No.: US 2004/0183837 A1
(43) Pub. Date: Sep. 23, 2004

(54) Document management method and apparatus

(75) Inventors: Norito Watanabe, Tokyo (JP); Ichiro Harashima, Tokyo (JP); Hisanori Nonaka, Tokyo (JP); Shunsuke Minami, Tokyo (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/763,661

(22) Filed: Jan. 23, 2004

(30) Foreign Application Priority Data
Mar. 17, 2003 (JP) 2003-071212

(51) Int. Cl. G09G 5/00

(52) U.S. Cl. 345/853

(57) ABSTRACT

A document management method and apparatus include and realize a process of generating a task information package datum as a set of data in order to manage information of referred documents and created documents in compiling a new document necessary for carrying out a task, a data base to store the task information package datum in one or more data bases and a processor to present relevant information as a graphical chart that shows relational linkage among plural documents in a manner of reference to other documents wherein the reference is recorded in the task information package datum, respectively. The task information package datum to record information of referred documents and compiled documents has a record of comment information such as knowledge and finding obtained in carrying out said task. The present invention can provide clear and comprehensive relational linkage of the information (preferably documents) for the purpose of task execution.

### FIELD OF THE INVENTION

The present invention relates to information technology or preferably a document management technology, or more specifically, a technology to provide the background information relevant to the task to be carried out by presenting many compiled documents in relation to the task.

### BACKGROUND OF THE INVENTION

As a conventional document management technology, there isapriortechnologyas (JP, 11-073459, A (1999)), whichraises the file retrievability and accessibility by relating the document files to tasks to be carried out.

Reference

Published Japanese Patent Application: JP, 11-073459, A(1999)

The conventional technology has a merit such that it can easily retrieve the documents related to the task, however the relational linkage is a way such that one task is linked with the documents. But it is difficult to comprehend a group of documents compiled for plural tasks. Since the conventional technology is purposed for setting a relation between the task and the documents beforehand, it is difficult to comprehend the background knowledge relevant to the task.

### BRIEF SUMMARY OF INVENTION

The present invention has an advantage to store a task information package datum, which includes a document to be complied and the reference documents which is used in the compilation of such a document as a set of data, in a data storage device and to present the reference information of the registered documents and the relational linkages among the plural compiled documents in a display.

By using this information of the relational linkage, it is possible to make a consolidated relational linkage for each task. In other words, since it is possible to refer to the same file in plural tasks, no explicit file is necessary to be set for the reference and the user is not necessary to be aware of accessing the storage device that stores the files. In addition, it is possible to retrieve the information of all files which have been referred when a file is compiled by using the task information package datum and therefore it is possible to obtain the background knowledge.

Further advantage of the present invention is that the task information package datum has a function to keep the knowledge obtained in carrying out the task, in addition to the information of the referred documents and of the compiled documents as comment information (such as knowledge and finding obtained in carrying out the task, for example, in a form of annotation or remarks).

By using the task information package datum, it is possible to systematically comprehend the background knowledge by tracing the past progress details in compiling the documents based on such comments information.

These advantages and other ones are described in the claims and the following discussions.

### BRIEF DESCRIPTION OF THE DRAWINGS

FIG. 1 is a block diagram that shows the system construction in the present invention.

FIG. 2 is a graphic presentation for package data registration.

FIG. 3 is a chart that shows a data process of the consolidated system operation in package data registration.

FIG. 4 is an example of an explanatory schematic that shows document data stored in the document data base.

FIG. 5 is an example of an explanatory schematic that shows the relational linkages between the task information package datum and the documents.

FIG. 6A and FIG. 6B are examples of presentation of relevant information as a graphical chart.

FIG. 7 shows an example of task information package datum that has index column.

FIG. 8 is an example of system construction for extracting from the index information.

FIG. 9 is an example of a task information package datum that has index information.

FIG. 10A, FIG. 10B and FIG. 10C are examples of presentation of an example shown in FIG. 9.

FIG. 11A and FIG. 12B are examples of presentation of whole nesting shown in FIG. 9.

FIG. 12 is an example of graphic presentation used for analytical studies.

### DETAILED DISCRIPTION OF THE INVENTION

To begin with, we will discuss an embodiment with regard to the present invention.

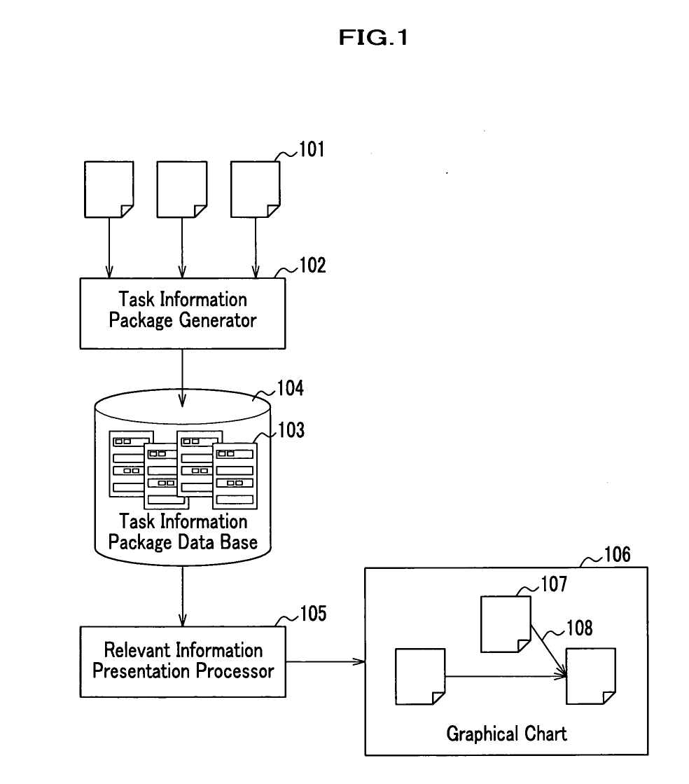

FIG. 1 shows a diagram that shows the system construction in the present invention.

A user directs an instruction, being input to an instruction input device (which is not shown in FIG. 1), to a task information package generator 102 that makes a pack of the information of documents referred in compiling the document which is currently under compilation and the information of the resultantly compiled present document 101 when the user is engaged in a document task. The task information package generator 102 stores the instructed information as one data set of task information package datum 103 in a task package data base 104. It is meant “task” is, for example, writing patent specifications, compiling design documents and CAD drawings, analytical studies, etc. As carrying out package generation for every task, plural task information package data 103 are stored in task information package data base 104. The substantial information of the documents which are the resultant ones after carrying out the task can be separately stored in a document managing data base (then linking information is stored in the task information packaging data 103). The document may store the address information to assess Web page in an internet.

After carrying out the task, the user accesses the relevant information presentation processor 105 in order to visualize a linkage of a group of documents in a graphical chart. In such access, the relevant information presentation processor 105 retrieves the information stored in the task information package data base 104 and presents a graphical chart on the display 106. In this graphical chart, the documents are presented by document icons and the reference of documents and the creation of documents are presented in arrow icons 108.

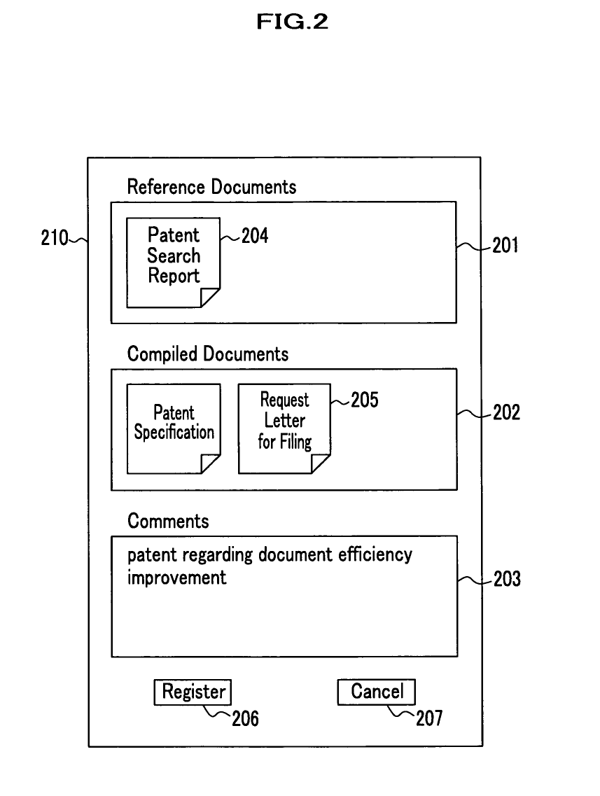

The window of graphic registration presentation 210 shown in FIG. 2 is an example used for a graphic registration presentation associated with the task information package datum 103. The registered graphic registration presentation 210 has a reference document field 201 to which the documents referred to the task are input and displayed, a complied document field 202 to which the compiled document is input and displayed and a comment field 203 to which the comment with regard to the task is input and displayed. The input has been done through “drag and drop” of file, “copy and paste” and selection from file browsers.

FIG. 2 is an example for a task for writing patent specifications. The reference document field shows “patent search report” 204. The documents compiled in reference to this report are “patent specification” and “request letter for filing” 205 in the complied document field 202. The comment field 203 shows the sentences of comments therein.

After inputting all above information, the task information package generator 102 operates and the resultant packed data are stored in a task package data base 104 by accessing the icon of register 206.

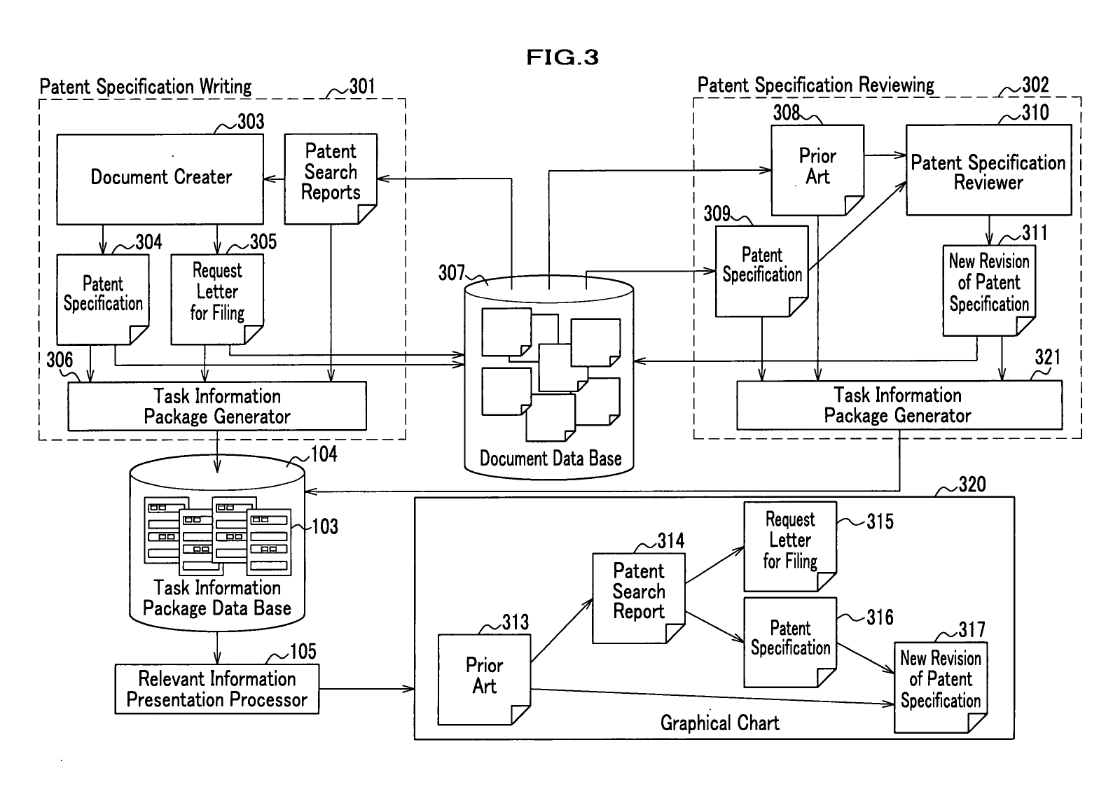

FIG. 3 shows a data process of the consolidated system operation, where two tasks, such as writing patent specifications denoted as 301 (called “a patent specification writing task”, hereinafter) and reviewing patent specification for amendment denoted as 302 (called “patent specification reviewing task”, hereinafter), are shown in a linkage.

In the patent specification writing task 301, patent specification 304 and request letter for filing 305 are made with referring to patent search reports in the document creator 303. At the termination of this task, the user activates the task information package generator 306 and accesses to the registered graphic registration presentation 210 as shown in FIG. 2. The user drags and drops the reference documents and compiled documents into the reference document window and the compiled document window, respectively and writes his or her comments in the comment window. The task information package generator 306 dumps and stores the task information package datum 103 into the task information package data base 104 by clicking the registration icon 206. The user may directly store the texts of the compiled documents into the document data base 307, however by accessing the register icon 206 on the registered graphic registration presentation 210 he or she may store these texts into the document data base 307 through the task information package data generator 306 such that these texts are stored in the task information package data base 104 as well as transferred to the document data base 307 and stored therein.

After filing patent specifications to Patent Office, it sometimes happens that the applied patents need to be reviewed for the patentability, meritoriousness, etc. The patent specification reviewing task 302 can be associated in such review. The patent evaluator 310 is carried out with referring to the prior arts 308 that are the objects to be studied and the prior revisions of patent specifications 309 (same as the patent specifications 304). After such patent evaluation, the new revision of patent specification 311 is resultantly compiled and stored in the document data base 307. The user can access the task information package generator 321 (same as 306) and input the task information through the graphic registration presentation 210. In the operation, the reference documents are the “prior arts” 308 and “patent specifications” 309 and compiled document is “new revision of patent specification” 311. The user can input the necessary comments and record them. By accessing the register icon 206, the user can store the task information package into the task information package data base 104.

After operating these plural tasks in a multi-task operation capability of the computer system, the user access relevant information presentation processor 105. By this access, the relational linkage in the original sources in document referencing and the original sources in document compilation can be obtained by retrieving the related data from the task information package data base 104 and present on the graphic chart display 320. The “patent specification” icon 316 is generated in the patent specification writing task 301 and the data file of “patent specifications” are treated as members of task information package generated in the patent specification reviewing task 302. By this membership property, it can be shown that the icon 314 of “patent search report”, the icon 316 of “patent specification” and the icon 317 of “new revision of patent specification” are all in a systematic linkage.

The operation of the relevant information presentation processor 105 ends up with the graphical chart presentation 320 in the following order of operation. To begin with, the user reads out all task information package datum 103 from the task information data base 104 and retrieve the documents registered in the reference and compilation files. By reading the date of document creation, the icons 313 to 317 corresponding to the order of creation are placed from the left to right and the upper to the lower. After this operation, by using the task information package datum 103, the user connects the icon corresponding to the reference documents to the icon corresponding to the created documents with arrows. If the icons overlap with the arrows, it is possible to rearrange the position of icons in such a way that the overlaps are in the minimum. By using this relevant information presentation processor, it is possible to create a graphic chart presentation of the reference and relevant information.

Besides ordering the icons of the documents in document compilation date, it is possible to create a nesting of relations in compilation and reference by which a priority order of compilation can be obtained. The icons of the documents can be placed in the order in such a priority order. The priority order of compilation is the information that describes the reference of task information package datum and the relational linkage of document compilation so that the generation of sequential tasks is specified. Since no closed loops are created in the reference nesting, the relational linkage is uniquely created.

There is another method of graphical chart presentation that does not use the information of order of compilation, wherein one of the re-arrangements of icons is carried out in such a way that icons corresponding to documents do not overlap and the lengths of the arrows indicating the relational linkages are kept as homogenous as possible. Then the relationship among the documents can be analyzed by applying a spring model.

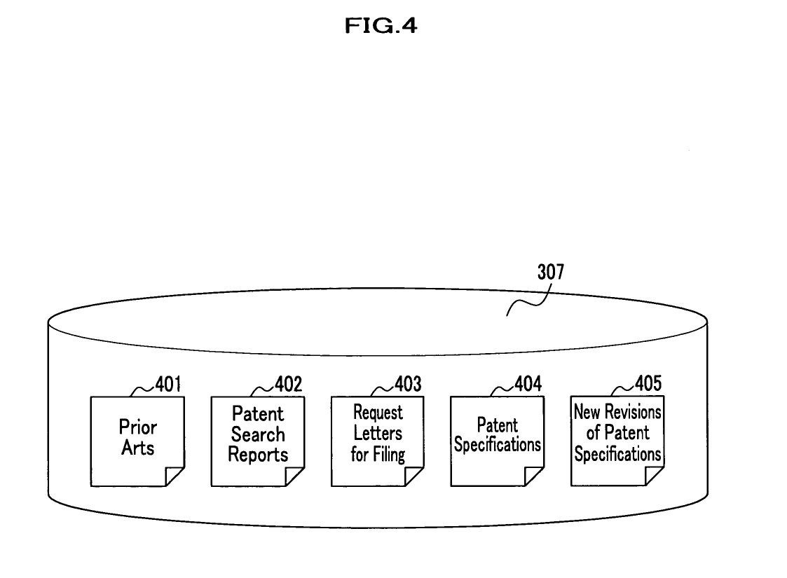

The document data, which is the conclusive results of the tasks, are stored in the document data base 307 as shown in FIG. 4. The prior arts 401, patent search reports 402 and request letters for filing 403, patent specifications 404 and new revisions of patent specifications 405 are all stored therein in a computer accessible form.

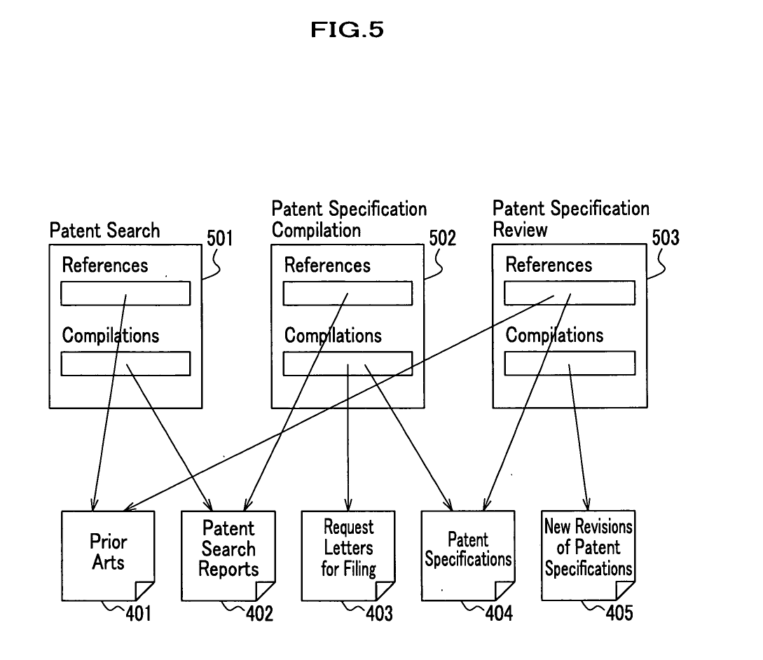

The relational linkage of these documents is obtained by nesting the information in the task information package datum stored in the task information package data base 104. FIG. 5 shows the nesting with regard to the task information package datum 501 for patent searching task, the task information package datum 502 for patent specification writing and the task information package datum 503 of patent specification reviewing that have relational linkages with the document data 401 to 405 stored in the document data base 307. FIG. 5 shows the status that the document data of the patent search reports 402 are under compilation with referring the document data of the prior arts 401. The graphical chart presentation 320 in FIG. 3 shows the visual presentation of these relational linkages.

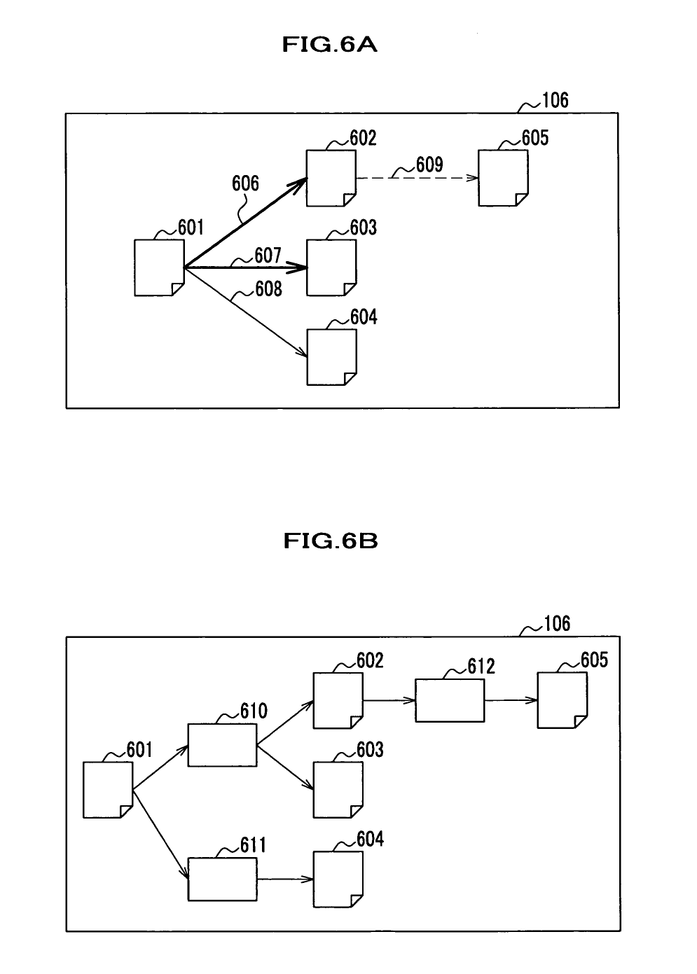

There are several methods for the visualization of the relation between the tasks and the documents such as a graphical chart presentation as shown in FIG. 6 besides the presentation of the linkage in arrows as shown in FIG. 3. FIG. 6A shows the relational linkages of the icons 601 to 605 of the documents are presented in the arrows 606 to 609 that differ in colors, kinds and thickness of lines on the basis of the variation of the tasks. By such differences of lines, the kind of tasks can be easily clarified. Since the difference of the arrows is specified in the difference of the tasks, it is possible to make it clear that there is difference of the tasks even though the document is complied from the same reference document if the task is different. FIG. 6B shows another method for the visualization of the relation between the tasks and the documents, where the comment information stored in the task information package datum is inserted and shown as icons 610 to 612 in between the icons of documents. By using this presentation, it is possible to show the time-sequential comment information generated and the time-sequential background knowledge and the finding obtained in the process of the document compilation. The presentation of the comment information as shown in FIG. 6B can be applied to the FIG. 6A in a way such that the comment information is revealed by directing the arrows 606 to 609 using the selecting means such as cursors. The operation is carried out in the following steps. The user selects one of the arrows 606 to 609 using selecting a cursor or an alternative. Then the user accesses the relevant information processor presentation 105 and directs the presentation of the comment information therein and the relevant information processor presentation 105 retrieves the task information package datum corresponding to the arrow. Consequently, the relevant information processor presentation 105 presents the comment information stored in the corresponding task information package datum. There is another method for such presentation of the comment information where the user is not necessary to explicitly direct the presentation of the comment information. It is possible for the user to only place the cursor close to the one of the arrows 606 to 609, and then relevant information processor presentation 105 starts to retrieve the corresponding comment information and shows a presentation such that the corresponding comment information pops up near by the selected arrow. Since the cursor shifting, selection of icons by arrow and pop up presentation of comments are general presentation function of GUI, the details will not be explained.

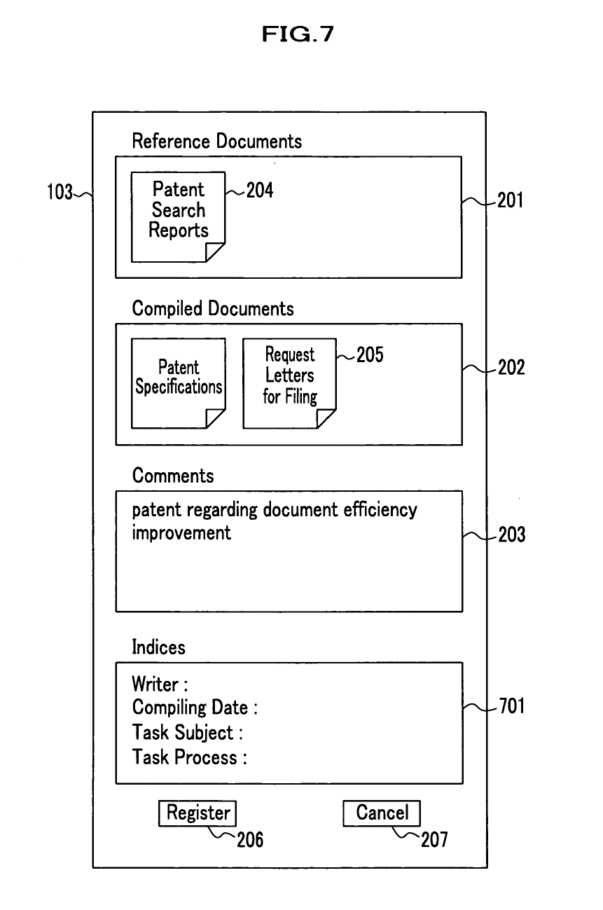

FIG. 7 shows another example of task information package datum.

In this example, index information 701 is added to the task information package datum as explained in the first embodiment. For the index information, “writer”, “compiling date”, “task subject”, “task process”, are used. This group information is stored in accessible form in the present relational data base.

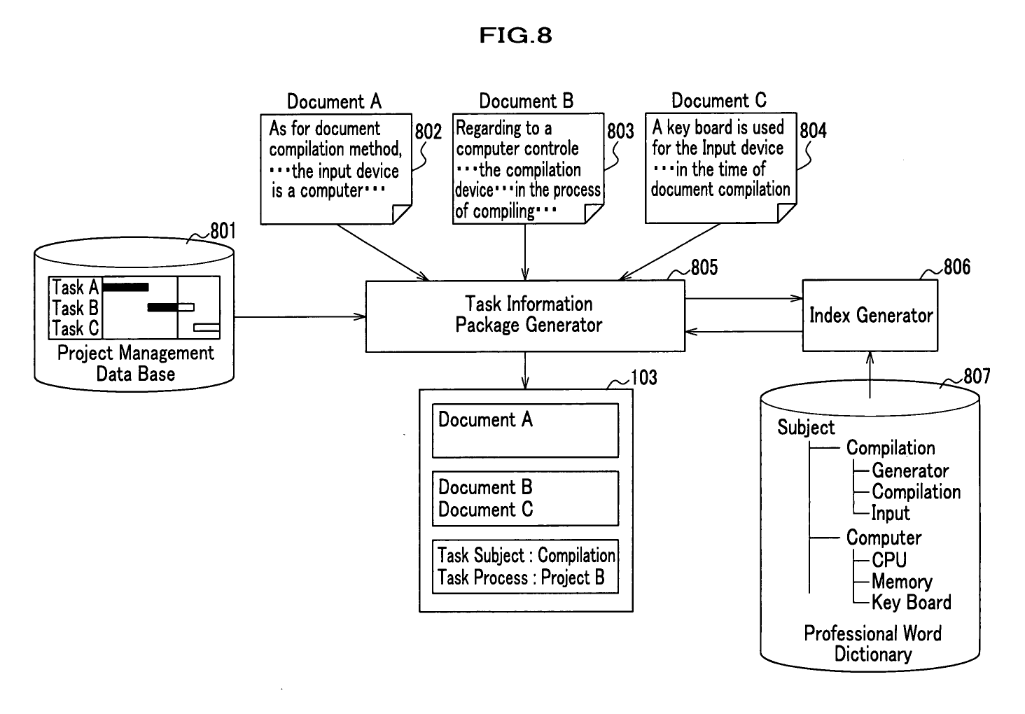

The user who stores the task information package datum in the task information package data base can directly input the information into the index column every time when he or she updates the recorded information. Alternative operation method can be automatically or semi-automatically done by the index generator 806 as shown in FIG. 8. The detail operation is explained as follows.

The writer in the index information 701 can be obtained from the name of computer user who operates the present document management system and therefore the generation of writer's name can be automatically or semi-automatically done. And the compiling date in the index information 701 is obtained by the generic information of the present user of the computer.

The task subject in the index information 701 is explicitly presented from the candidates of the remarkable words extracted from the input documents. For this purpose, the task information package generator hands over the input documents to the index generator 806. The index generator 806 applies morphological analysis to the document by words and terminology registered in a professional word dictionary 807 and extracts the resultant words. The morphological analysis is realized by the general used application as follows. The sentences in the input documents are decomposed into a part of speech. The index generator 806 selects the technical terms which are same as the terms registered in the professional word dictionary 807. These selected technical terms are a set of terms representing the remarks to specify the property of the document. On the basis of this information, the frequency of the fact that the technical terms come out in the subjective document is counted. The task information package generator 805 collects sets of technical terms and their frequency for each subjective document. By using this information, the task information package generator 805 presents the technical terms commonly used for all documents in the order of frequency. The user can select the candidates for the technical terms which are most preferable for the index information of the task information package generator. By this process, the most preferable index can be made for the task information package datum with a little burden to the users.

The professional word dictionary 807 can be configured in a system of a data base by constructing hierarchy of words. By implementing the relational access in the intra-hierarch, it is possible to manage the broader terms and narrow terms and retrieve the words in this management concept. It is possible to automatically judge the correspondence of each candidate of the index to the remarks of the index. In other words, the user can select correct index data 701 against the remarks such as “task subject” and “task process”. FIG. 8 shows an example such that since the index candidate 37 compile” extracted from the document is a narrow term of “task subject” in the professional word dictionary 807, “compile” index is set for “task subject” index remarks in the task information package datum 103. The user can select broader terms against the subjective term which has been extracted from the index information. For this case, the user can easily select the appropriate term by using presented terms on the basis of only the subjective terms and the broader terms. In the example shown in FIG. 8, the user can obtain the presentation of “compile operation” which is a broader term and select it to operate.

If the system has a project management system or project management data base 801, the task information package generator 805 accesses the present status information stored in the task progress project management system or project management data base 801 and the retrieved information is set in the task process index. It is possible to exploit the present general relational data base management system for the project management system. In the project management system, the term of operation (days), starting time and ending time are managed by the project management data base 801. The user can comprehend which project his or her present document compiling task is related to and can set these documents to the corresponding task process index.

The texts of the document A 802, the document B 803 and the document C 804 show the word “compile” is commonly used thereover as seen in FIG. 8. The task subject is set to be “compile” for the index information in the task information package datum. The user comprehends that the project B is presently carried on by referring the task information package data base 801 through the task information package generator 805 and sets “project B” in the task process in the information package datum 108.

We will explain an example to use index information 701 in the presentation for a graphical chart in the following.

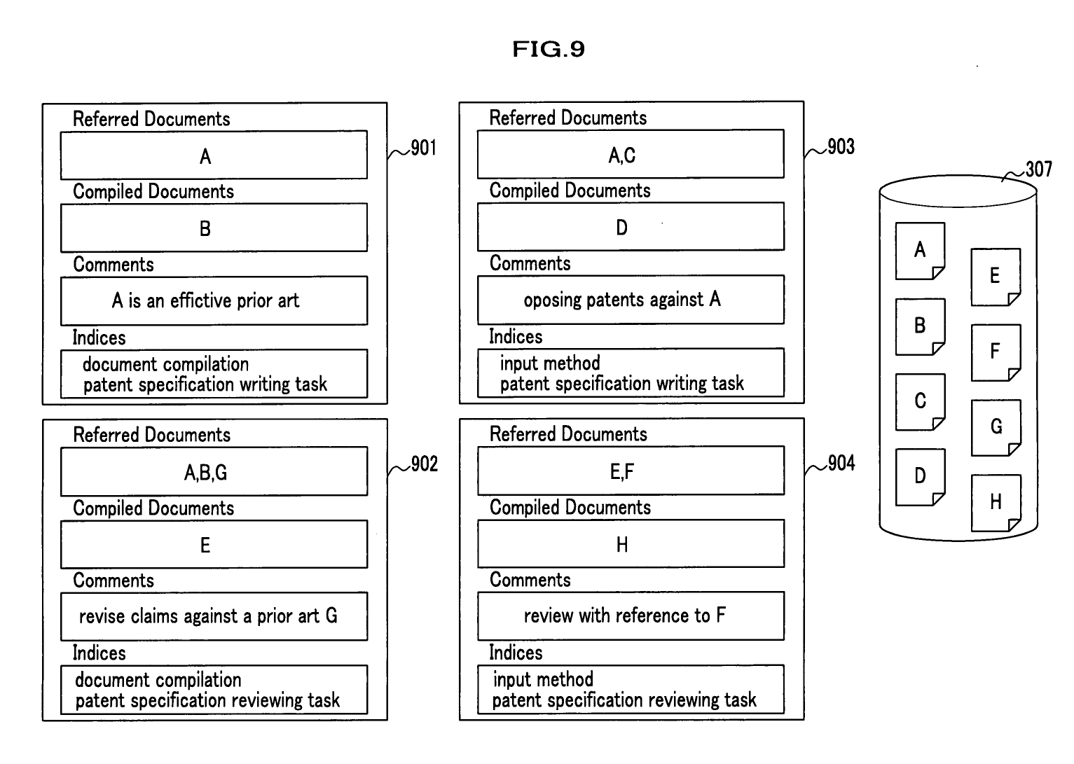

FIG. 9 shows an example wherein four task information package datum 901 to 904 are stored in task information package data base 307. The task information package datum 901 refers to the document A, complies document B and has a comment “A is an effective prior art”. The index of this task information package datum has the index “document compilation” and “patent specification writing task”. In the task information package datum 902, the task information package datum refers to the documents A, B and G, compiles the document E and has the index “document compilation” and “patent specification reviewing task”. The task information package datum 903 and another datum 904 have similar form as shown in FIG. 9. The actual texts of the documents referred in the task information package data are stored as the documents A to H in the document data base 307.

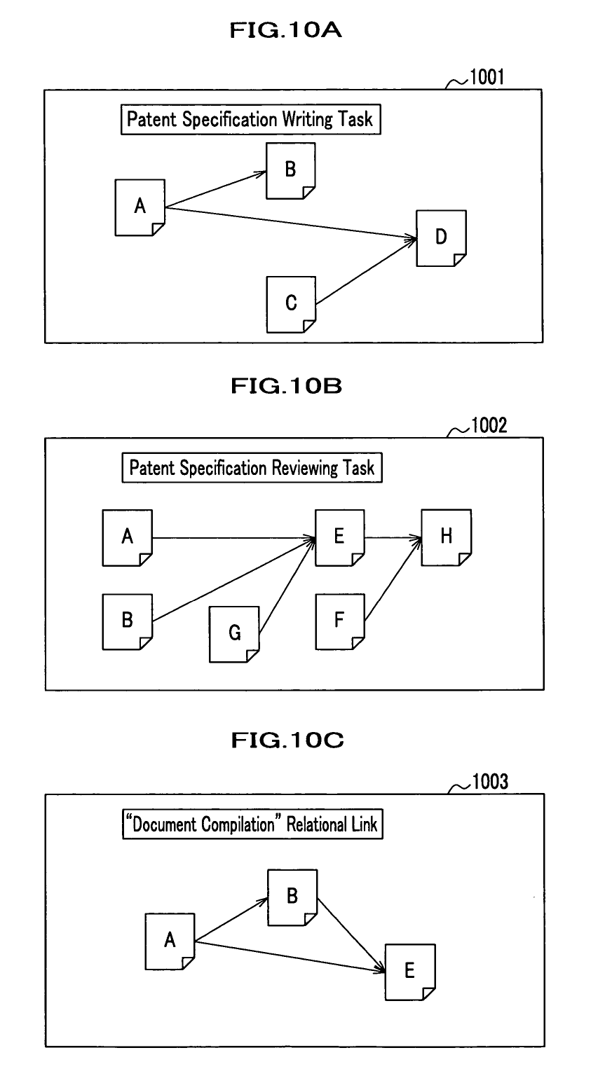

The relevant information presentation processor 105 provides the graphical chart presentation as shown in FIG. 10. The arrangement of the icons of the documents is done in a process as explained for the relevant information presentation processor 105 shown in FIG. 3. FIG. 10A shows a graphic chart 1001 which is compiled in a view of “patent specification writing”. For this operation, the user retrieves all “patent specification writing” set in the index of the task information package data and present as the relational linkage among the retrieved task information package data. It is seen the documents B and D are compiled from the document A and the document C is compiled from the document D. As a similar presentation, the graphic chart 1002 in FIG. 10B shows the relational linkage of the patent specification reviewing and the graphic chart 1003 in FIG. 10C shows that of the document compiling. By this system configuration, the nesting of all categories of the relational linkages is not presented but done in confined categories that are interesting to the user.

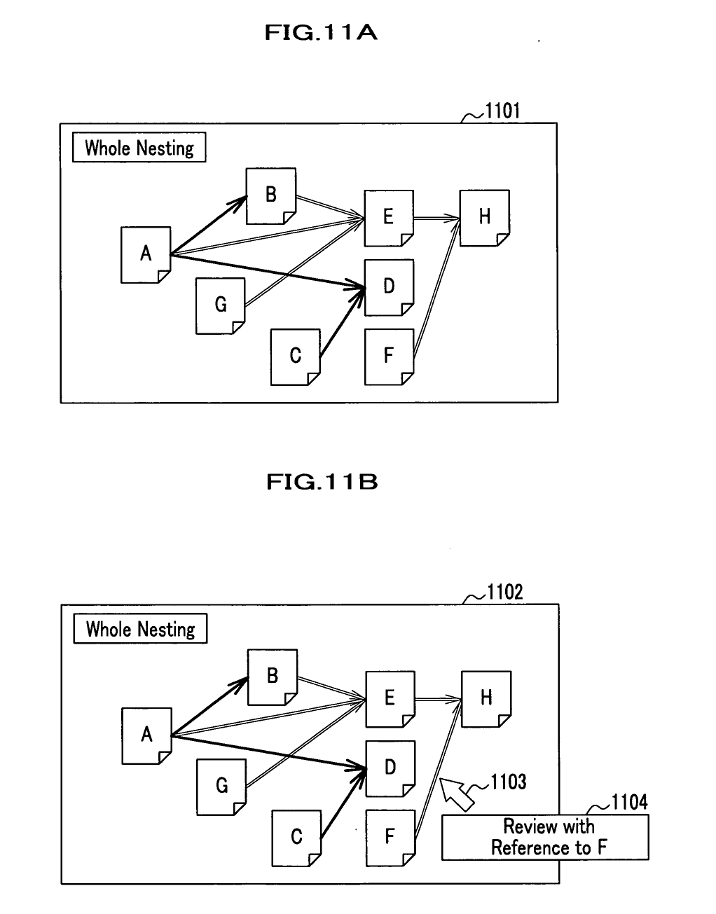

FIG. 11 shows variations of arrow indicator in different colors, different kinds and different thickness of lines as shown in the graphical chart 1101. It is possible not to present only the relational linkage among the documents but the classification of such relational linkage between documents. As shown in the graphical chart 1102, the pop up window 1104 comes out to present the background knowledge and the finding by directing the cursor 1103 to the arrows.

Another example of application of the present invention is explained as follows, wherein the graphical presentation for designing task which uses computer simulation technology is carried out. It is necessary to search the various parameters and determine in a manner of trial and error in the process of on-CAD designing task. The present invention provides the graphical chart presentation of the background knowledge and the finding obtained in the design process for the optimization,

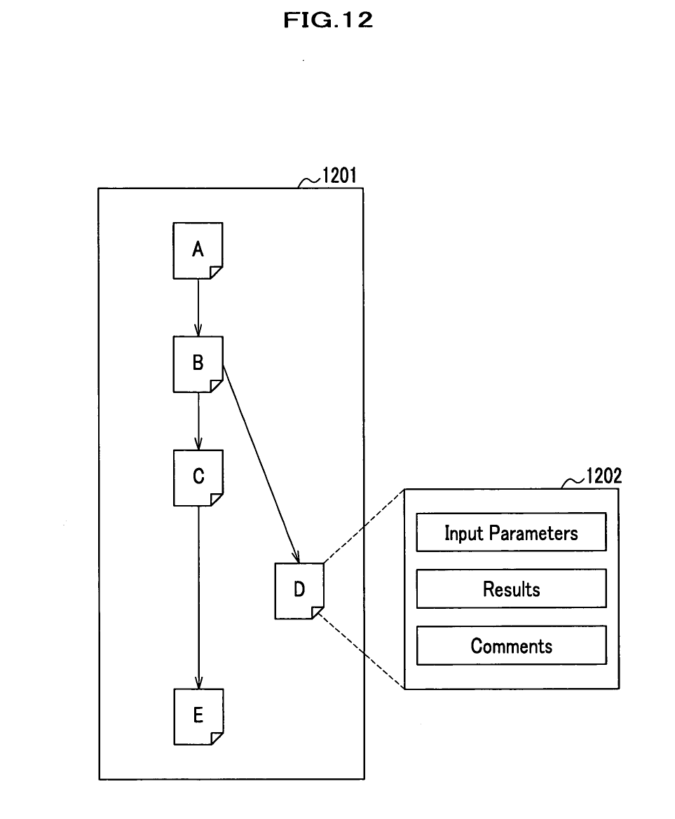

The graphical chart 1201 shown in FIG. 12 is such an example. The document icons A to E show analysis results for a trial. For every analysis of the design simulation, the user records a reference analysis result, the input parameters for the latest program for analysis and the analysis result and the comments in the task information package datum. After completing several trials of design, the design task has been completed. The design process is presented in a graphical chart 1201 by using the relevant information processor presentation 105. The graphical chart does not present only the relational linkage of the documents (which are the results of the analysis) but the time-series order of the documents. Therefore the process of the trial for the analysis is clearly presented. In the graphical chart 1201, a new window 1202 shows the input parameter set used for the current analysis, the results of the analysis and the comments obtained in carrying out the task by directing the icon D with a cursor. It is also possible to start a new analysis while a past document is being selected for access. In this operation, an icon of a new document (which is an analysis result) is generated from the document (which is a past analysis result) as a reference information. The input parameter set of the document which is selected as the reference is used for the new analysis. The new document data (which is the new analysis result), the reference and document compilation relation are stored in a new document icon in which the input parameter set is updated with that used for the analysis.

The systems shown in FIG. 1, FIG. 3 and FIG. 8 are constructed by the general computer hardware system and the computer software cooperating therewith. It is possible to construct the present invention in a dedicated system such as foreground graphical control and background computation for the simulation computation or the data transfer operation among plural data bases.

In constructing the system for the present invention, the computer software program stored in a CD-ROM or a portable HDD is dumped into the system memories or the system hard disk of the computer system controlled by the central process unit. When the software program is distributed by a communication channel such as an internet, the program is once received in the file server and dumped to the system disk of the computer system that operates for the document management regarding the present invention. For the purpose of operating the present document management, personal computers, office computers and work stations can be used.

In the above embodiment and examples, the system regarding the present invention can store all compiled documents in packages for every task, wherein the documents are used for the document management and the document retrieval and allows the user to easily comprehend the background knowledge and the finding by graphically presenting the relational linkage among the documents retrieved from a group of packages stored in the data base. There is a file system that has a hierarchy structure to manage a huge amount of documents. However the strict hierarchy needs restoring all these documents after when the storing system or rule of the documents has been changed. Since each document is kept in an independent file, it is not possible to comprehend the relational linkage among the documents. There is a solution to define a linkage of the relevant documents to each of the tasks. However the solution provides a linkage particular to the task and does not support the user to comprehend a group of documents created for plural tasks. In addition, it is difficult to comprehend the background knowledge and the finding both obtained during carrying out the tasks. And the difficulty still remains after completing all relevant tasks and projects. The present invention has an advantage to solve these problems by such a system that comprises the task information package generator to manage the task information package datum of the referred documents and the created documents in the compilation of the documents, the task information package data base to store the task information package datum and relevant information presentation processor that processes the presentation of the relational linkage such as reference to, compilation from and revision of other documents with regard to a specified document recorded in the task information package datum. The task information package generator has a function to register the comment information such as the knowledge and the finding obtained in carrying out in addition to the information of the referred documents and the compiled documents. The function to register the comment information can be implemented in another functional block independent from the task information package generator.

In this system, it is possible to make a consolidated relational linkage for each of the tasks with retrieving all document information over the task information package data base. Since it is possible to refer to a file for the purpose of plural tasks, it is not necessary to explicitly create an file on a basis of directory system and therefore the users are not necessary to be aware of or careful to the storage directory of the file. It is possible to retrieve the information of which referenced document was used for a specific document and therefore possible to obtain the background knowledge and the finding at the time of creating the document. By tracing up the comment information, it is possible to comprehend the background knowledge and the finding regarding the document. It supports to clarify the relational linkage of the documents that have been created and referred to in the compilation of the document. The present system has no such hierarchy used for the conventional file management system and therefore it is not necessary to restore all documents after when the storing system or rule of the documents has been changed. It is possible to systematically comprehend the background knowledge and the finding after the completion of the tasks since the present system presents the creation process of the documents.

What is claimed:

1. A document management method comprising:
a process of generating a task information package datum as a set of data in order to manage information of referred documents and created documents in compiling a new document necessary for carrying out a task,
a process of storing said task information package datum in one or more data bases, and
a process of presenting relevant information as a graphical chart that shows relational linkage among plural documents in a manner of reference to other documents wherein said reference is recorded in said task information package datum.

2. A document management method defined in claim 1, wherein;
information of referred documents, compiled documents and comment information such as knowledge and finding obtained in carrying out said task are recorded in said process of generating a task information package datum.

3. A document management method defined in claim 1 or claim 2, wherein;
icons to present documents and arrows to present referenced documents and compiled documents are used in said process of presenting relevant information as a graphical chart.

4. A document management method defined in claim 2, wherein;
icons to present documents and arrows to present referenced documents and compiled documents are used in said process of presenting relevant information as a graphical chart, and
a process to present a pop up window to present said comment information is included in said process of presenting relevant information as a graphical chart.

5. A document management method defined in claim 2, wherein;
said process of generating a task information package datum includes a process to record at least one of information among a name of a writer, date of compilation, a subject of a task and a process name of said task as index information therein.

6. A document management method defined in claim 5, wherein;
said index information is obtained by morphological analysis which is applied to sentences described in said referred documents, said created documents and said comment information with a profession word dictionary which manages technical terms.

7. A document management method defined in claim 5, wherein;
said index information is set by using information of a system which manages processes of said task.

8. A document management method defined in claim 5, wherein;
said process of presenting relevant information as a graphical chart works for processing to present only relevant information given in said index information.

9. A document management apparatus comprising:
a task information package generator to generate a task information package datum as a set of data in order to manage information of referred documents and created documents in compiling a new document necessary for carrying out a task,
one or more data bases to store said task information package datum, and
a relevant information presentation processor to present relevant information as a graphical chart that shows relational linkage among plural documents in a manner of reference to other documents wherein said reference is recorded in said task information package datum.

10. A document management apparatus defined in claim 9, wherein;
said task information package datum to record information of referred documents and compiled documents has a record of comment information such as knowledge and finding obtained in carrying out said task.

11. A document management apparatus defined in claim 9, wherein;
icons to present documents and arrows to present referenced documents and compiled documents are used in said relevant information presentation processor that presents said relevant information as a graphical chart.

12. A document management apparatus defined in claim 10, wherein;
icons to present documents and arrows to present referenced documents and compiled documents are implemented by said relevant information presentation processor that presents relevant information in a graphical chart, and a process to present a pop up window to present said comment information is done by said relevant information presentation processor.

13. A document management apparatus defined in claim 9, wherein;
said task information package generator additionally records at least one of information among a name of a writer, date of compilation, a subject of task and a process name of said task as index information therein.

14. A document management apparatus defined in claim 13, wherein;
said index information is generated by morphological analysis which is applied to sentences described in said referred documents, said created documents and said comment information with a profession word dictionary which manages technical terms.

15. A document management apparatus defined in claim 13, wherein;
said index information is generated by using information of a system which manages processes of said task.

16. A document management apparatus defined in claim 13, wherein;
said relevant information presentation processor that presents relevant information in a graphical chart works to present only relevant information given in said index information.

17. A computer software program that allows a computer to execute said document management method defined in claim 1.

18. A computer readable recording medium that records said computer software program which allows a computer to execute said document management method defined in claim 1.

19. Information management method comprising:
a process to manage a package information that consolidates text information and linkage information showing a relational linkage thereof to external files, and
a process to obtain a candidate information to be recorded in said package information from progress of task, comment information and said external files.

20. Information management method defined in claim 19 including:
a process to manage updated information as historical data in a manner of said package information, and
a process to present at least one of tasks, names of writers, indices and versions after obtaining relational linkages of documents over a group of said package information.
